(19) United States
(12) Patent Application Publication
(10) Pub. No.: US 2009/0036011 A1
(43) Pub. Date: Feb. 5, 2009

(54) FORMALDEHYDE-FREE BINDER

(76) Inventors: Hagen Hunig, Ladenburg (DE); Eva Wagner, Altrip (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/095,002

(22) PCT Filed: Nov. 27, 2006
(86) PCT No.: PCT/EP06/68933

§ 371 Date: Oct. 14, 2008

(30) Foreign Application Priority Data
Nov. 28, 2005 (DE) 102005056791

(51) Int. Cl. B32B 17/02; C08K 5/17; C08L 5/00

(52) U.S. Cl. 442/180; 524/243; 524/247; 524/188; 524/27; 264/172.11

(57) ABSTRACT

The present invention concerns a composition, containing: an aqueous dispersion of at least one polymer polycarboxylic acid; at least one amine compound, wherein the molecular mass of the amine compound does not exceed approximately 20 000 g/mol; as well as at least one activated silane. The composition in accordance with the invention is suited as a formaldehyde-free binder for the manufacture of bound mineral wool.

The present invention concerns a formaldehyde-free composition to be used for the manufacture of insulation products made of mineral wool, a binder for mineral wool comprising the said composition, a method for the manufacture of mineral wool bound in a formaldehyde-free manner, as well as the bound mineral wool product thus obtained.

In the manufacture of bound mineral products from a molten glass or mineral material, it has for a long time been accepted practice to apply, following fiberization of the molten material, a binder on the basis of phenol-formaldehyde resin on the fibers while they are still hot. This preferably takes place in the chute following fiberization, e.g. in accordance with the blast drawing process according to DE 35 09 426 A1.

Here a phenol-formaldehyde resin, being the best-known binder of the prior art, is preferably sprayed onto the fibers in the form of an aqueous solution, or dispersion, wherein the phenol-formaldehyde resin then begins to polymerize on the fiber surface owing to the still relatively high temperatures of the fibers, and connects the single fibers with each other as a result of the polymerization process, particularly at crossing points of fibers, inasmuch as the fibers lying on top of each other at a crossing point are more or less embedded there by solidified droplets of resin, and thus the relative mobility of the single fibers is initially impeded and later on prevented entirely upon curing by means of hot gases, for instance inside a tunnel furnace.

A like binder is described, e.g., in U.S. Pat. No. 3,231,349. For reasons of protection of the environment as well as for reasons of workplace safety, more and more attempts are meanwhile being undertaken to replace the conventional phenolic resin binders with alternative, formaldehyde-free binders because of their formaldehyde content and their formaldehyde emission.

Thus for example EP 0 583 086 B2 describes a curable, formaldehyde-free, aqueous binder composition for glass fibers on the basis of polymer polyacids containing at least two carboxylic acid groups or anhydride groups, which comprises a polyol containing at least two hydroxyl groups and a phosphorus-containing catalyst, wherein a ratio of the number of equivalents of COOH group to OH group must be from 0:0.01 to 1:3.

A polymer polyacid described in EP 0 583 086 B2 is, for instance, polyacrylic acid.

A preferably used polyol is β-hydroxyalkylamide, e.g., [N,N-di(β-hydroxyethyl)]-adipamide, however it is also possible to use, e.g., ethylene glycol, glycerol, pentaerythritol, trimethylol propane, sorbitol, sucrose, glucose, resorcinol, catechol, pyrogallol, glycolated ureas, 1,4-cyclohexane diol, diethanolamine, or triethanolamine.

Similar binder compositions for mineral fibers are, e.g., also known from U.S. Pat. No. 6,331,350 B1, EP 0 990 727 A1, EP 0 990 728 A1, and EP 0 990 729 A1. The listed documents of the prior art also use a polyacrylic acid as a polymer polyacid. By way of a polyol, alkanolamines as well as glycols are also used there.

In addition, EP 0 882 074 B1 describes binder compositions for mineral fibers on the basis of polyacrylic acids and glycols as polyols.

EP 1 232 211 B1 discloses binder compositions for the manufacture of shaped articles of natural or synthetic, finely divided or fibrous materials with a polymerizate of 0 to 50% (wt.) of at least one ethylenically unsaturated dicarboxylic acid, the anhydrides and/or the salts thereof and 50-100% (wt.) of at least one ethylenically unsaturated monocarboxylic acid and/or the salts thereof, wherein up to 10% (wt.) of the acidic, ethylenically unsaturated monomers may be replaced with other ethylenically unsaturated monomers copolymerizable with the acidic ethylenically unsaturated monomers, and at least one amine which may contain less than two OH groups, in such a quantity that the pH value of the binder is situated in the range of 2 to 7, as well as 0.5 to 30% (wt.) of a crosslinking agent on epoxy or acrylate resin basis.

Another prior art is WO 2005/087837 A1 which discloses a formaldehyde-free binder for mineral fibers which has the following composition:
(a) a polyacid component with acid groups or an anhydride or salt thereof, and
(b) a polyhydroxy component with hydroxyl groups, wherein the pH value of the binder composition is above about 7.

The expression “polyacid component” is understood in WO 2005/087837 to designate an unsaturated, saturated, or aromatic polycarboxylic acid, unsaturated or saturated cyclic polycarboxylic acid, hydroxyl-substituted derivatives thereof, as well as the salts and anhydrides thereof.

By the expression “polyacid component”, WO 2005/087837 thus only discloses a lower-molecular acid carrying several carboxyl groups, and no polymer polyacids whatsoever. Polyacids named to be suitable are in particular maleic acid, fumaric acid, succinic acid, citric acid, sebacic acid, adipic acid, aconitinic acid, butanetetracarboxylic acid dihydride, butanetricarboxylic acid, citraconic acid, dicyclopentadiene-maleic acid adducts, diethylenetriaminepentaacetic acid, adducts of diterpene and maleic acid, endomethylenehexachlorophtalic acid, ethylenediaminetetraacetic acid (EDTA), fully maleinated colophonium, maleinated tall oil fatty acids, fumaric acid, glutaric acid, isophthalic acid, itaconic acid, and halogenated derivatives of lower-molecular carboxylic acids.

Usable polyols are, e.g., polymer polyols of the polyvinyl acetate type.

All of the binder compositions of the prior art constituting an alternative for phenol-formaldehyde resins are, however, currently only conditionally suited for the manufacture of mineral wool products, mainly due to their lack of water resistance, so that, for example, the binders based on polyacrylate resins have hitherto generally been barred from practical use for the manufacture of mineral wool products.

Starting out from the prior art of EP 0 882 074 B1, it accordingly was an object of the present invention to furnish a formaldehyde-free binder composition which has, following curing, properties comparable with those of a phenol-formaldehyde binder without, however, having the emission problems of the latter.

The solution of this object is achieved through a formaldehyde-free composition, a binder comprising said composition, a method for the manufacture of mineral wool bound in a formaldehyde-free manner, the product thus obtained, as well as the use of the said composition for bonding the mineral wool in a formaldehyde-free manner.

In particular, the present invention concerns a composition containing:
an aqueous dispersion of at least one polymer polycarboxylic acid;
at least one amine compound of the general formula (1)

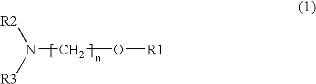

wherein:
   R1, R2 and R3 independently of each other, equal or not equal, corresponds to H and R1 of the general formula (2):

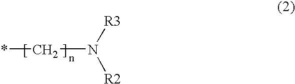

with a value for n of 2-10, and
R2 and R3, independently of each other, are equal or not equal to H or correspond to the general formula (3):

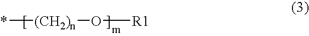

wherein m may assume a value of 1-50,
and the molecular mass of the amine compound does not exceed approximately 20 000 g/mole;
at least one activated silane,
   which may be obtained by a conversion of a silane, selected from the group: mono-, di-, and trialkoxysilanes having one C₁ to C₈ alkoxy group, wherein the alkoxysilane carries at least one C₂ to C₁₀ aminoalkyl group or a C₂ to C₁₀ N-aminoalkyl group; 3(2-aminoethylamino)propyl-trimethoxysilane; (MeO)₃—Si—(CH₂)₃—NH—(CH₂)₃—Si—(OMe)₃; 3-aminopropyl-silanetriol; amino-silane with ethoxylated nonyl-phenolate; phenyl-CH₂—NH—(CH₂)₃—NH—(CH₂)₃—Si—(OMe)₃*HCl; as well as mixtures thereof;
   with an enolizable ketone having at least one carbonyl group or a ketone having at least one OH group, wherein the ketone contains 3 to 12 C atoms.

In the polymer polycarboxylic acid of the present invention, the polycarboxylic acid is selected from the group consisting of: polyacrylates, polymethacrylates, copolymerizates of acrylic acid and olefinic carboxylic acids having at least two carboxyl groups and having altogether 4 to 20 C atoms.

According to the present invention, the polymer polycarboxylic acid has a molecular mass between approx. 500 and 20,000, particularly between approx. 500 and 10,000, preferably between approx. 500 and 5,000.

It is furthermore a preferred embodiment of the present invention that the polymer polycarboxylic acid is end-capped. i.e., reactive groups are deactivated with a suitable capping agent.

For the use as a binder in the manufacture of mineral wool it is a great advantage that in the customary dilutions between 5-50%, the composition has a processing time, particularly a pot life, of approx. 6 h-48 h.

It is a preferred embodiment of the present invention to select the amine from the group consisting of C₂ to C₁₀ alkanolamines, particularly ethanolamine, diethanolamine and triethanolamine.

A preferred silane of the composition in accordance with the invention is 3-aminopropyltriethoxysilane. It is commercially available at a low cost.

As ketones for the manufacture of the activated silane, dihydroxyacetone or acetylacetone are preferably employed due to their easy availability, however the activated silane may also be produced with an enolizable ketone having at least one carbonyl group or a ketone having at least one OH group, wherein the ketone contains 3 to 12 C atoms.

The composition in accordance with the invention may, of course, additionally contain at least one surface modifying agent, particularly a hydroxymethylphenol and a hydroxyphenol, preferably resorcinol, preferably in a quantity between approx. 0.1 and 1% (mass) relative to the total solid matter.

Furthermore it is frequently desirable for the composition to additionally contain at least one crosslinking agent, with those being preferred that are selected from the group consisting of: glycerol, polyols, neopentylglycol, trimethylallylamine, 1,3,5-triallyl-2-methoxybenzene, 1,1,1-tris(4-hydroxyphe-nyl)ethane, triallyineopen-tylether, pentaerythrite, sugars, sugar molasse; as well as mixtures thereof.

It is particularly preferred if the composition in accordance with the invention has a pH value in the range of approx. 5.5 to 9.5, more preferably 7.5 to 8.5. Hereby it is on the one hand ensured that conduits and nozzles, particularly spraying nozzles, are less subjected to corrosion than with the acidic binder compositions of the prior art. On the other hand compositions in the preferred pH range do by far not attack the mineral or glass fiber to the extent as the prior art compositions that are distinctly more acidic.

The composition in accordance with the invention is excellently suited as a binder for mineral wool. On the one hand it is thus possible to manufacture positively formaldehyde-free mineral wool products, and on the other hand the binders of the invention and thus, of course, also the mineral wool products are water-resistant after curing.

In order to manufacture mineral wool bound in a formaldehyde-free manner by means of the binder of the invention, the binder is applied, following fiberization of a molten mineral material, on the fibers while they are still hot, and the mineral wool product with the applied binder is subjected to a curing process. Here the binder is particularly applied on the fibers in the chute by spraying the fibers attenuated from the molten mineral material.

A bound mineral wool product manufactured in accordance with the method of the invention satisfies any mechanical and chemical requirements just like a mineral wool product bound by using classical phenol-formaldehyde resin.

Without being bound thereto, the activation of the silane with the carbonyl compound possibly appears to unfold in accordance with the following reaction scheme, as is shown by two different carbonyl compounds:

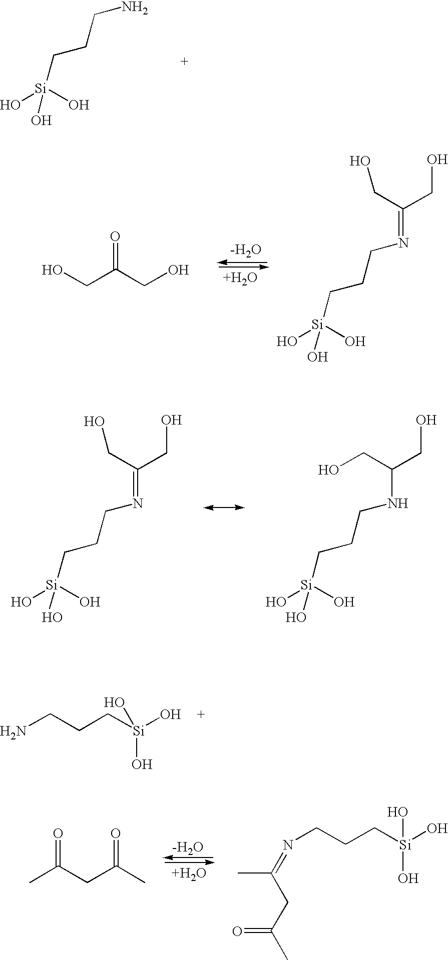

As a result of the activation of the silane—in the above reaction scheme by way of the example of the γ-aminopropylsilanetriol having resulted from hydrolysis of 3-aminopropyltriethoxysilane—by reaction with an enolizable ketone having at least one carbonyl group or a ketone having at least one OH group, wherein the ketone contains 3 to 12 C atoms, there is formed on the activated molecule a “resin side” which is formed by the N part, in addition to a glass side formed by the Si part.

In the prior art, the amino group of the silane was reacted with formaldehyde into a Schiffs base which in turn reacted with the phenol-formaldehyde resin.

Thus a formaldehyde content of the binder as required in the prior art is not necessary any more because the activated silane carries an N-containing molecule portion which is capable of coupling to the resin—in accordance with the invention to the reaction product of the polyacrylate with the amine compound, particularly alkanolamine, but also to the ring of activated aromatic systems by performing a C-alkylation—which is thus bound via the silane linker to the glass surface of the hot fiber.

The reactions of the activated silanes used in accordance with the invention at the glass surface—presently represented by a silica tetrahedron—are in the following shown schematically and exemplarily without being bound thereby:

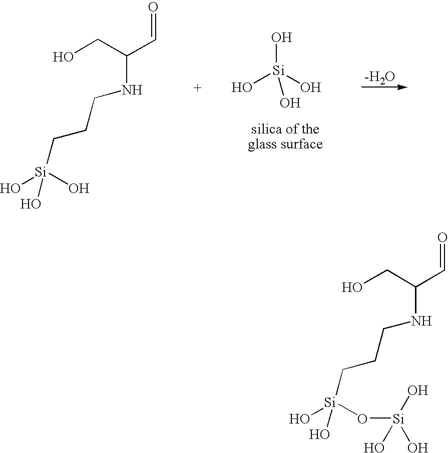

These hydrolytic linkings take place rapidly on the fiber while it is still hot.

Further advantages and features of the present invention become evident from the description of practical examples as well as from the drawings, wherein:

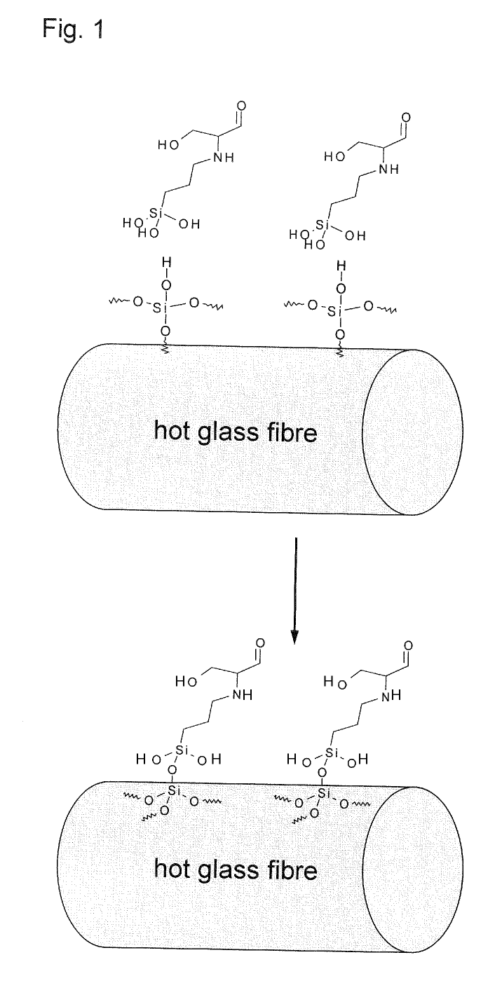

FIG. 1: is a schematic view of silanes coupled to a glass fiber via the Si portion of an activated silane;

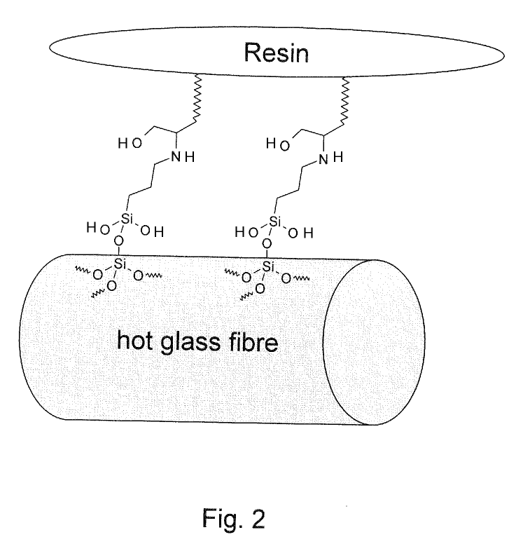

FIG. 2: is a schematic view of a resin bound to a glass surface on a fiber via an activated silane; and

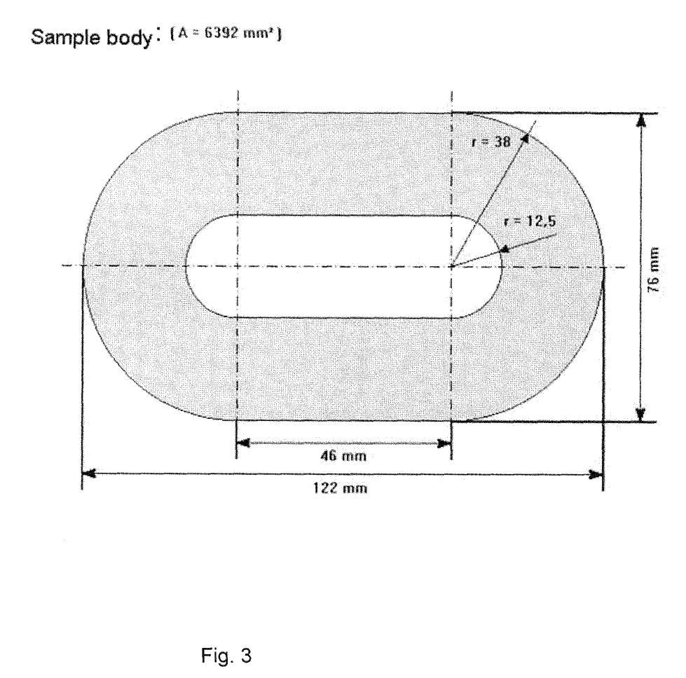

FIG. 3: shows dimensions of a sample body for the determination of ring tearing strength.

The overall context of the composition in accordance with the invention and binder in connection with the manufacture of mineral or glass fibers is once again visualized in FIG. 1 and FIG. 2.

Here the represented molecular arrangement should merely be understood in a schematic manner. Crosslinking reactions may, of course, for example take place purposely with crosslinking agents and the alkanolamine still inside the resin, exemplarily polyacrylate. As a matter of fact it is also possible for unintended secondary reactions to occur, as is true with any polymerization. The contents of FIGS. 1 and 2 may therefore merely be considered to be a model concept which is, however, helpful for an understanding of the invention.

### PRACTICAL EXAMPLES

The neutralized resins were tested in the laboratory and on the finished product in accordance with various testing methods. The results were compared with those of the standard phenolic resin (Binder 1) and with a commercially available, polyacrylate-based acidic binder (Binder 2). The manner of proceeding is explained by the following examples and only represents a small selection of the test results. The substances employed in the examples given are only representative for their functionalities; thus, e.g., the used dihydroxyacetone may readily be replaced with acetone, acetyl acetone or acetacetic acid, the ethanolamine with another primary alkanolamine, or the mixture of hydroxymethylresorcins nearly at will with any hydroxymethylated phenols. The employed polyols, or the silanes, are equally extraordinarily variable.

In the binders a target concentration of 40% total solid matter was generally aspired. The pH values of the neutralized polyacrylates are between 8.1 and 8.4, the pH value of the binder based on commercially available polyacrylate is 2.5-3.0.

### COMPARATIVE EXAMPLES

### Binder 1

### Standard

A typical prior art, alkali-catalyzed phenolic resin having a total solid matter content of 44% was used. Composition: 150 kg of phenolic resin; 35.5 kg of urea; 1.0 kg of ammonium sulfate; 2.0 kg of ammonia solution (25%); 25.8 kg of 3-aminopropyltriethoxysilane (2%); 44.6 kg of water.

### Binder 2

### Acrylate 1

A commercially available polyacrylate-based binder having a total solid matter content of 52% and a pH value between 2.5 and 3.0 was used. 150 kg of this binder were admixed with 46.0 kg of water and 0.4 kg of 3-aminopropyltriethoxysilane.

In the following practical examples of the invention, the following general prescription for the representation of an activated silane is valid:

In a vat including a mechanical stirrer of a suitable size, a part of the dilution water is initially charged. Then the corresponding quantity of the carbonyl compound is added and stirred until complete dissolution. In the case of compounds poorly soluble in water, careful heating is performed, or a dispersant is added under vigorous stirring. The silane is added to the solution, and then stirring is continued until a distinct change of color of the solution. A more intense coloration indicates the formation of the imine as activated silane. The silane thus activated is added to the binder batch. Following homogeneization, the binder is ready for use and may be processed for Examples 1 and 2 during approx. 6 hours.

### Example 1

### Binder 3

### Acrylate 2

A commercially available, non-neutralized polyacrylate-maleic acid copolymerizate having a total solid matter of 46% was used. Composition: 150 kg of copolymerizate; 60.3 kg of ethanolamine; 0.9 kg of hydroxymethyresorcinols; 0.4 kg of 3-aminopropyltriethoxysilane; 0.3 kg of dihydroxyacetone; 9.2 kg of pentaerythrite; 6.7 kg of glycerol, 140.0 kg of water.

The finished preparation has a pH value of approx. 8.2.

### Example 2

### Binder 4

### Acrylate 3

A commercially available, non-neutralized polyacrylate with a total solid matter of 50% was used. Composition: 150 kg of polyacrylate; 45.3 kg of ethanolamine; 1.0 kg of hydroxymethyresorcinols; 0.4 kg of 3-aminopropyltriethoxysilane; 0.3 kg of dihydroxyacetone; 8.5 kg of pentaerythrite; 6.2 kg of glycerol; 129.0 kg of water.

The finished preparation has a pH value of approx. 8.2.

### Performance of Quality Tests

### 1. Laboratory Tests

### 1.1 Adhesion of the Binder on the Glass

Circular glass pieces having a diameter of 7 cm, or a surface area of 38.5 cm², were used. The surface area was determined by counting with the aid of a grid template. The values were rounded.

On a circular pièce of fire-polished glass having a composition in accordance with EP 1 522 532 A1, 5 drops of a 20% binder solution are distributed homogeneously. The film is initially dried at 50° C. in order to avoid inhomogeneities, and subsequently cured during 2 h at 150° C. The coated pieces are stored in water at 70° C. during 24 h. Then the surface area proportion of the stripped resin is determined. A binder with a technically meaningful use should still adhere by at least 75% of the surface area to the glass after the test. The results are summarized in Table 1.

TABLE 1
Adhesion of the binder to glass

| | Area of stripped resin | Percentage of |
|---|---|---|
| Binder | in cm² | stripped resin |
| 1 | <1 | <2 |
| Standard phenolic resin | | |
| (comparison 1) | | |
| 2 | >29 | >75* |
| Polyacrylate, not neutralized | | |
| (Comparison 2) | | |
| 3 | 3.8 | 10 |
| (Copolymerizate, neutralized) | | |
| 4 | 3.1 | 8 |
| (Polyacrylate, neutralized ) | | |

*Film partly dissolved

2. Tests with Mineral Wool Products Manufactured with the Binder of the Invention

With the above binders in accordance with Examples 1 to 2, mineral wool products were manufactured where following fiberization of the molten material, e.g. in the blast drawing process, the binder was sprayed on the fibers in the customary manner in the chute while they were still hot.

The obtained products were then subjected to a series of tests that are described in the following.

2.1 Ring Tearing Strength of Insulation Materials Before and after Autoclaving

Ring tearing strengths before and after autoclaving

What was tested was a clamping felt having a target bulk density of 11 kg/m³ and a target loss due to burning of 4.5%. Changes in curing temperatures or curing periods relative to the standard phenolic resin were not carried out.

### Method

Tubular, oval test samples were stamped from the finished product. Half of the test samples thus obtained are torn apart by means of a suitable apparatus. The other part is aged in air saturated with water vapor during 15 min. at 105° C. and subsequently torn apart in the same way. The measured tearing forces provide an indication of the strength of the overall system glass fibers-resin after manufacture and of its resistance under normal conditions of use. The testing method is customarily used for insulation materials having a low specific gravity, preferably with clamping felts. In standard products without hydrophobizing agents, strength losses due to autoclaving between 20 and 30 percent are normal. The results are summarized in Table 2. It should be noted that even the non-neutralized polyacrylate (binder 2) after manufacture, which served as a comparison, did not reach the strengths of the other binders following ageing.

TABLE 2
Ring tearing strength

| | Tearing strength | Tearing strength | |
|---|---|---|---|
| | after manufacture | after autoclaving | Strength loss in |
| Binder | in N/g | in N/g | percent |
| 1 | 3.35 | 2.73 | 18.5 |
| [Comparison 1] | | | |
| 2 | 1.44 | 1.15 | 20.1 |
| [Comparison 2] | | | |
| 3 | 3.71 | 2.65 | 28.6 |
| [Example 1] | | | |
| 4 | 3.65 | 3.10 | 15.1 |
| [Example 2] | | | |

The binders 2, 3, 4 were used in this test without dust binder oil, as the objective was to examine the behaviour of the pure binder-glass system.

The ring tearing strength of insulation materials is tested at the applicant's as in the following detailed representation:

The testing method serves for determining the maximum tearing force of oval mineral wool rings. What is determined is the force required to achieve tearing of the sample body, which is indicated as the tearing strength in N/g.

The sample bodies used are oval mineral wool rings in accordance with a shape represented in FIG. 3, which are punched out by means of a punching apparatus with corresponding tool. These rings are punched from mineral wool products (boards, felts, etc.). Care must be taken to punch the sample body across the entire width and without tilting. Coatings must be removed. The sample bodies are stored, prior to testing, at least during 24 h at (23±5)° C. and (50±5) % relative humidity.

Prior to testing, the weight in grams must be determined for each sample with an accuracy of 0.01 g. The sample bodies are subjected to tensile stress at a test velocity of 300 mm/min until tearing takes place, and the maximum manifesting force is registered in N (tearing force). A second set of sample bodies is subjected to a simulated climatic conditioning where they are incubated in the autoclave at 105° C. during 15 min.

Following the climatic conditioning, the moist sample bodies are dried in a drying cabinet at 105° C. during at least 1 hour. At bulk densities [RD] upwards of 50 kg/m³, the drying period must be extended correspondingly. This is followed by cooling to ambient temperature.

The further manner of proceeding corresponds to tests for samples without climatic conditioning.

The ring tearing strength σ_{R} before and after autoclave treatment is calculated as follows:

$$Ring tearing strength {σ}_{R} = \frac{Tearing force [ N ]}{Sample weight [ g ]}$$

The respective average value from 6 sample bodies in the lengthwise and crosswise directions must be calculated. The average values must be indicated to an accuracy of one tenth of a unit.

$$Strength reduction = \frac{R - {σ}_{RA}}{R} \cdot 100 [ \% ]$$

wherein
_{R}=average value of the ring tearing strength prior to climatic conditioning
_{RA}=average value of the ring tearing strength after climatic conditioning

The corrected ring tearing strength relative to nominal bulk density is calculated as:

$${σ}_{R , N} = \frac{( \frac{{σ}_{R , i} + {σ}_{R , q}}{2} ) \cdot {RD}_{N}}{{( \frac{{RD}_{i} + {RD}_{q}}{2} )}^{\text{?}}}$$

$$\text{?} \text{indicates text missing or illegible when filed}$$

wherein
_{R, N}=nominal average value of the ring tearing strength
_{R, l}=average value of the ring tearing strength longitudinal to the line direction
_{R, q}=average value of the ring tearing strength transversal to the line direction
   RD_{N}=nominal bulk density
   RDₗ=bulk density longitudinal to the line direction
   RD_{N}=bulk density transversal to the line direction
   2.2 Thickness Change Resulting from Nordtest

What was examined was a product having a target bulk density of 50 kg/m³ and a target loss due to burning of 3.7%. The starting thickness was 50 mm, the thickness of the annealed material an average of 160 mm. The binders based on acrylic acid were here cured at temperatures 20° C. higher than the standard phenolic resin.

For performing these tests, sample bodies having an edge length of 20×20 cm are cut from a finished product. One part of the sample bodies is annealed at 450° C. in order to determine the thickness of the respective material without bonding. The other part is stored for 7 days at 70° C. and 95% relative humidity. This test has become known under the designation of “Nordtest”.

The thickness change is determined in proportion to the starting thickness. The thickness of the annealed material represents the maximum attainable value. The method is customarily employed with products having a medium specific gravity. A binder with a technically meaningful use maintains the thickness change below 20% of the starting value, or 10% of the maximum value, respectively. In the case of a binder having insufficient strength, a thickness change is observed even without the Nordtest. The results are summarized in Table 3.

TABLE 3
Thickness change due to Nordtest

| | | | Change in % |
|---|---|---|---|
| | Thickness after | Thickness after | from maximum |
| Binder | manufacture (mm) | Nordtest (mm) | value |
| 1 | 50 | 55 | 3 |
| [Comparison 1] | | | |
| 2 | 70 | 140 | 56 |
| [Comparison 2] | | | |
| 3 | 50 | 65 | 9 |
| [Example 1] | | | |
| 4 | 50 | 60 | 6 |
| [Example 2] | | | |

Thus the examinations carried out confirm that the composition in accordance with the invention is not only fundamentally suited as a formaldehyde-free binder for the mineral wool manufacture, but also practically applicable in accordance with the established product quality, processing capability, and economy. The existing machine equipment need not be modified, and as the pH value may be adjusted to >7, more intense corrosion than with the classical binder need not be feared.

1. A composition, containing:
an aqueous dispersion of at least one polymer polycarboxylic acid;
at least one amine compound of the general formula (1) 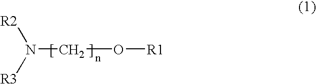
wherein:
R1, R2 and R3 independently of each other, equal or not equal, corresponds to H and R1 of the general formula (2): 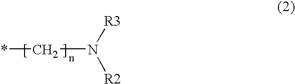
with a value for n of 2-10, and
R2 and R3, independently of each other, are equal or not equal to H or correspond to the general formula (3): 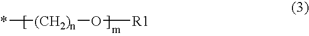
wherein m may assume a value of 1-50,
and the molecular mass of the amine compound does not exceed approximately 20 000 g/mole; and
at least one activated silane,
which may be obtained by a conversion of a silane, selected from the group consisting of: mono-, di-, and trialkoxysilanes having one C₁ to C₈ alkoxy group, wherein the alkoxysilane carries at least one C₂ to C₁₀ aminoalkyl group or a C₂ to C₁₀ N-aminoalkyl group; 3(2-aminoethylamino)propyl-trimethoxysilane; (MeO)₃—Si—(CH₂)₃—NH—(CH₂)₃—Si—(OMe)₃; 3-aminopropyl-silanetriol; amino-silane with ethoxylated nonyl-phenolate; phenyl-CH₂—NH—(CH₂)₃—NH—(CH₂)₃—Si—(OMe)₃*HCl; as well as mixtures thereof;
with an enolizable ketone having at least one carbonyl group or a ketone having at least one OH group, wherein the ketone contains 3 to 12 C atoms.

2. The composition in accordance with claim 1, characterized in that the polycarboxylic acid is selected from the group consisting of: polyacrylates, polymethacrylates, copolymerizates of acrylic acid and olefinic carboxylic acids having at least two carboxyl groups and having altogether 4 to 20 C atoms.

3. The composition in accordance with claim 1, characterized in that the polymer polycarboxylic acid has a molecular mass between approx. 500 and 20,000.

4. The composition in accordance with claim 1, characterized in that the polymer polycarboxylic acid is end-capped.

5. The composition in accordance with claim 1, characterized in that the amine compound is selected from the group consisting of C₂ to C₁₀ alkanolamines, diethanolamine and triethanolamine.

6. The composition in accordance with claim 1, characterized in that the silane is 3-aminopropyltriethoxysilane.

7. The composition in accordance with claim 1, characterized in that the ketone is dihydroxyacetone or acetylacetone.

8. The composition in accordance with claim 1, characterized in that it additionally contains at least one surface modifying agent, selected from the group consisting of: a hydroxymethylphenol a hydroxyphenol, and resorcinol, in a quantity between approx. 0.1 and 1% (mass) relative to the total solid matter.

9. The composition in accordance with claim 1, characterized in that it additionally contains at least one crosslinking agent.

10. The composition in accordance with claim 9, characterized in that the crosslinking agent is selected from the group consisting of: glycerol, polyols, neopentylglycol, trimethylallylamine, 1,3,5-thallyl-2-methoxybenzene, 1,1,1-tris(4-hydroxyphenyl)ethane, triallylneopentylether, pentaerythrite, sugars, sugar molasse; as well as mixtures thereof.

11. The composition in accordance with claim 1, characterized in that it has a pH value in the range of approx. 5.5 to 9.5.

12. A binder for mineral wool, containing a composition in accordance with claim 1.

13. A method for the manufacture of mineral wool bound in a formaldehyde-free manner with a binder in accordance with claim 12, wherein the binder is applied, following fiberization of a molten mineral material, on the fibers while they are still hot, and the mineral wool product with the applied binder is subjected to a curing process.

14. The method in accordance with claim 13, characterized in that the binder is applied on the fibers in the chute by spraying the fibers attenuated from the molten mineral material.

15. A bound mineral wool product, obtained by a method in accordance with claim 13.

16. A method for the manufacture of a mineral wool product bound in a formaldehyde-free manner using a composition in accordance with claim 1.
